(19) United States
(12) Patent Application Publication
(10) Pub. No.: US 2007/0290804 A1
(43) Pub. Date: Dec. 20, 2007

(54) WIRELESS COMMUNICATION APPARATUS

(75) Inventor: Toshinori KOMESU, FUKUOKA (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/761,540

(22) Filed: Jun. 12, 2007

(30) Foreign Application Priority Data
Jun. 13, 2006 (JP) 2006-163153

(51) Int. Cl. H04Q 5/22

(52) U.S. Cl. 340/10.1; 340/572.7; 340/10.2; 455/129; 455/83

(57) ABSTRACT

The invention includes a first antenna section, a second antenna section, a transmitting signal generating section configured to generate a predetermined transmitting signal for a wireless tag, a transmitting section configured to transmit the transmitting signal generated by the transmitting signal generation section from the first antenna section, and a receiving section configured to receive a response signal from the wireless tag through the second antenna section. Furthermore, the invention is constituted to include an error detecting section configured to detect a predetermined error in the response signal sent from the wireless tag and received by the antenna section, and an antenna switching section configured to carry out switching for receiving the response signal sent from the tag through the first antenna section and transmitting the predetermined transmitting signal through the second antenna section based on a result of the detection obtained by the error detecting section.

### BACKGROUND

1. Field of the Invention

The present invention relates to a wireless communication apparatus communicating with a wireless tag by utilizing a radio wave in a UHF band.

2. Description of the Prior Art

In a UHF band wireless communication (reader/writer) apparatus, conventionally, one antenna for transmission/receipt sharing is used to communicate with a wireless tag. However, a response power transmitted from the wireless tag is small for a transmission power. In recent years, therefore, a method configured by dividing an antenna dedicated to a transmission and an antenna dedicated to a receipt has also been implemented.

For the communicating method of the wireless communication apparatus, similarly, there is generally employed a direct conversion method in which frequencies of a transmitting wave to a tag and a receiving wave are equal to each other. As a basic operation for a UHF band wireless communication apparatus, a radio wave is sent from the wireless communication apparatus to a wireless tag and a power supply on the wireless tag side is thus started. Then, AM (amplitude modulated) or PM (phase modulated) signal is sent to the wireless tag side in the wireless communication apparatus. In a transmission from the wireless communication apparatus, the transmission is carried out through an antenna dedicated to the transmission. On the wireless tag side, a signal sent from the wireless communication apparatus is received and information stored in a memory in the wireless tag is returned through a backscatter modulation. A response signal sent from the wireless tag is received through the antenna dedicated to the receipt in the wireless communication apparatus. Thus, a serial communication processing is completed.

FIG. 11 is a circuit block diagram showing a conventional wireless communication apparatus, and FIG. 12 is a circuit block diagram showing a conventional wireless tag. With reference to these drawings, an operation of a conventional UHF band wireless communication apparatus will be described below. In FIG. 11, 512 denotes a CPU (Central Processing Unit) configured to carry out data setting of a synthesizer 514, a power ON/OFF control (AM modulation) of a power amplifier 503 and a receive data processing of an AD converter 511. In the synthesizer 514, a carrier acting as a starting power supply of a necessary tag for communicating with a wireless tag and serving to deliver modulated data is generated. A frequency of a synthesizer signal can be changed every certain time in the case of a frequency hopping system.

In the case of a UHF band wireless communication apparatus, moreover, a band of 850 MHz to 960 MHz is used. An output of the synthesizer 514 is amplified by a transmitting amplifier 502. A carrier amplified by the transmitting amplifier 502 is input to a next power amplifier 503. In the power amplifier 503, the ON/OFF control of the power supply is carried out by the CPU 512. By the ON/OFF control of the power amplifier power supply, the carrier is AM modulated. An unnecessary spurious component is removed from the modulated wave subjected to the AM modulation through a band-pass filter 505. A radio wave is emitted from the modulated wave from which the spurious component is removed into a space through a transmitting antenna 506. Although a partial power is lost from the radio wave emitted to the space due to a propagation loss in the space, it is received through an antenna 520a of a wireless tag in FIG. 12 and is converted into a voltage for starting a CPU (Central Processing Unit) in the tag by a rectifying operation through a rectenna 520c.

A response signal sent from the wireless tag is received by a receiving dedicated antenna 515 in FIG. 11. The response signal which is sent from the wireless tag and is received through the receiving antenna is input to a distributor 507 and a received power thereof is equally divided into two parts. The power thus divided into two parts is input to mixers 508a and 508b. A local signal to be sent to the mixers has a frequency which is equal to the frequency of a transmitting signal generated in the synthesizer 514. A local frequency component is divided into a component having a phase delayed by 90 degrees through a phase shifter 515 and a component having a phase (zero degree) which is equal to that of a generated local frequency. Furthermore, a local signal having a phase difference of 90 degrees is input to the mixers 508a and 508b and a received signal is directly converted into a baseband signal.

An output mixed with a zero-degree local frequency component is set to be an I component and an output mixed with a 90-degree phase shifting local component is set to be a Q component. Unnecessary frequency components are removed from the I and Q signal components converted into the baseband signals through filters 509a and 509b. Then, the baseband signals are amplified to have a required level by receiving amplifiers 510a and 510b. The baseband signals amplified by the receiving amplifiers 510a and 510b are binarized through the A/D converter 511, and the receive data are demodulated by the CPU 512. The data thus demodulated are transferred to an external interface 513 through an I/O interface 513.

There has been described a flow of a communication processing of a conventional UHF band wireless communication apparatus in a method of communicating with a tag through a transmitting antenna and a receiving antenna. In the method, however, a communication range with the tag is small and a communication area is limited.

In order to supplement the defect, as shown in FIG. 13, there has been proposed a structure in which four transmitting antennas (530 to 533) to be coupled to a transmitting system circuit 550 and four receiving antennas (534 to 537) to be coupled to a receiving system circuit 551. With the structure, the four transmitting antennas are switched by three switches. Moreover, the four receiving antennas (534 to 537) are switched by three switches (544 to 546). With the structure, however, one of the transmitting antennas is changed over into one of the other transmitting antennas or one of the receiving antennas is changed over into one of the other receiving antennas so that a diversity effect is only obtained by a change in an antenna position. In the case in which a response signal sent from the wireless tag is subjected to a receiving disturbance due to various interferences, a sufficient diversity effect cannot be obtained and a large number of wireless tags cannot be read rapidly.

### SUMMARY

The invention provides a wireless communication apparatus comprising a first antenna section, a second antenna section, a transmitting signal generating section configured to generate a predetermined transmitting signal for a wireless tag, a transmitting section configured to transmit the transmitting signal generated by the transmitting signal generation section from the first antenna section, a receiving section configured to receive a response signal from the wireless tag through the second antenna section, an error detecting section configured to detect a predetermined error in the response signal sent from the wireless tag and received by the antenna section, and an antenna switching section configured to carry out switching for receiving the response signal sent from the tag through the first antenna section and transmitting the predetermined transmitting signal through the second antenna section based on a result of the detection obtained by the error detecting section.

It is an object of the invention to provide a wireless communication apparatus capable of rapidly reading information about a large number of wireless tags by a very simple structure.

### BRIEF DESCRIPTION OF THE DRAWINGS

FIG. 1 is a circuit block diagram showing a wireless communication apparatus according to a first embodiment of the invention,

FIG. 2 is a functional block diagram showing the wireless communication apparatus according to the first embodiment of the invention,

FIGS. 3(a) and 3(b) are diagrams showing switching of an antenna switch in the wireless communication apparatus according to the first embodiment of the invention,

FIGS. 4(a) and 4(b) are diagrams showing a control matrix of the antenna switch in the wireless communication apparatus according to the first embodiment of the invention,

FIGS. 5(a) to 5(c) are diagram showing a data flow and an antenna control between the wireless communication apparatus and a tag according to the first embodiment of the invention,

FIG. 6 is a flowchart showing an operation of the wireless communication apparatus according to the first embodiment of the invention,

FIG. 7 is a diagram showing a data flow and an antenna control between the wireless communication apparatus and the tag according to the first embodiment of the invention,

FIG. 8 is a flowchart showing the operation of the wireless communication apparatus according to the first embodiment of the invention,

FIG. 9 is a diagram showing a schematic structure of an antenna section in a wireless communication apparatus according to a second embodiment of the invention,

FIG. 10 is a diagram showing a control matrix of an antenna switch in the wireless communication apparatus according to the second embodiment of the invention,

FIG. 11 is a circuit block diagram showing a conventional wireless communication apparatus,

FIG. 12 is a circuit block diagram showing a conventional wireless tag, and

FIG. 13 is a diagram showing a schematic structure of an antenna section in the conventional wireless communication apparatus.

### DETAILED DESCRIPTION

### First Embodiment

A first embodiment of a wireless communication apparatus according to the invention will be described below with reference to the drawings.

### <Explanation of Body Apparatus A>

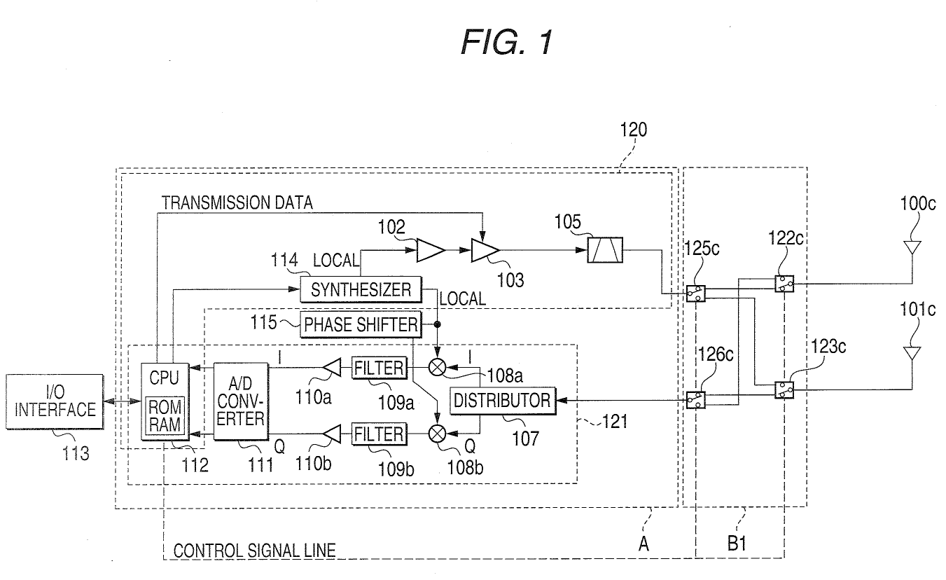

FIG. 1 is a block diagram showing a circuit structure of a wireless communication apparatus according to the first embodiment of the invention. FIG. 1 shows structures of a transmitting system circuit 120 and a receiving system circuit 121 in the wireless communication apparatus. In the first embodiment, moreover, a radio wave in a band of 850 MHz to 960 MHz is used.

In FIG. 1, a CPU 112 (Central Processing Unit) carries out data setting of a synthesizer 114, a power ON/OFF control (AM modulation) of a power amplifier 103, and a receive data processing of a receiving AD converter 111. Furthermore, a necessary carrier for a communication with a wireless tag is generated in the synthesizer 114. In a frequency hopping system, a frequency of the synthesizer signal thus generated can be changed every certain time. A signal output from the synthesizer 114 is amplified by a transmitting amplifier 102. The amplified carrier is input to the next power amplifier 103. In the power amplifier 103, the power ON/OFF control is carried out by the CPU 112. The carrier is subjected to the AM modulation by the ON/OFF control of the power amplifier 103. Next, an unnecessary spurious component is removed from the modulated wave subjected to the AM modulation by the power amplifier 103 through a band-pass filter 105. A radio wave is emitted from the modulated wave from which the spurious component is removed into a space through an antenna switching section B1 by means of a transmitting antenna 100c or a receiving antenna 101c so that a signal to be transmitted to the wireless tag is generated.

Moreover, a response signal sent from the wireless tag is received through the receiving antenna 101c or the transmitting antenna 100c. The response signal received from the wireless tag is input to a distributor 107 through the antenna switching section B1, and a received power is evenly distributed into two parts. Next, the power thus distributed into two parts is input to mixers 108a and 108b. A local signal to be transmitted to the mixers 108a and 108b has an equal frequency to the frequency of the transmitting signal generated in the synthesizer 114. The local frequency signal is distributed into a frequency signal obtained with a delay from the generated local signal in a phase of 90 degrees through the phase shifter 115 and a frequency signal in the same phase (zero degree) as the generated local frequency.

Next, the phase shifter 115 distributes the signal into two parts, and at the same time, generates a signal having a phase difference of 90 degrees with respect to the signals obtained by the distribution into two parts. More specifically, two local signals obtained by the distribution into two parts and having a phase difference of 90 degrees are input to the mixers 108a and 108b, and the received signals are directly converted into baseband signals. In the mixer 108a, a 0-degree local signal having an equal frequency to the frequency of the received signal is subjected to mixing. The received baseband signal subjected to an orthogonal demodulation is sent to an output of the mixer 108a. In the mixer 108b, next, a local signal having an equal frequency to the frequency of the received signal and a phase shifted by 90 degrees is mixed. The received baseband signal subjected to the orthogonal demodulation is sent to an output of the mixer 108b.

An output subjected to mixing with a 0-degree local frequency component is set to be an I component and an output subject to mixing with a 90-degree phase shifting local component is set to be a Q component. Unnecessary frequency components are removed through filters 109a and 109b from the I and Q signal components converted into the baseband signals. Then, the baseband signals are amplified to have a desired level by the receiving amplifiers 110a and 110b.

The baseband signals thus amplified are binarized by the AD converter 111 and received data are demodulated through the CPU 112. The data thus demodulated are transferred to an external interface through an I/O interface 113.

### <Explanation of Structure of Antenna Switching Section B1>

A transmitting frequency which will be described below can be applied to a system in a UHF band of 300 MHz to 3000 MHz.

In FIG. 1, an output transmitted from the transmitting system circuit 120 is controlled to be connected from an SPDT (Single Pole Double Throw) switch 125c to an SPDT switch 122c or an SPDT switch 123c. In the case in which the output is connected to the SPDT switch 122c, therefore, it is transmitted from the transmitting antenna 100c. In the case in which the output is connected to the SPDT switch 123c, moreover, it is transmitted from the receiving antenna 101c.

Similarly, an input sent to the receiving system circuit 121 is controlled to be connected from an SPDT switch 126c to the SPDT switch 122c or the SPDT switch 123c. In the case in which the input is connected to the SPDT switch 122c, it is received by the transmitting antenna 100c. In the case in which the input is connected to the SPDT switch 123c, accordingly, the transmitting signal is received by the receiving antenna 101c.

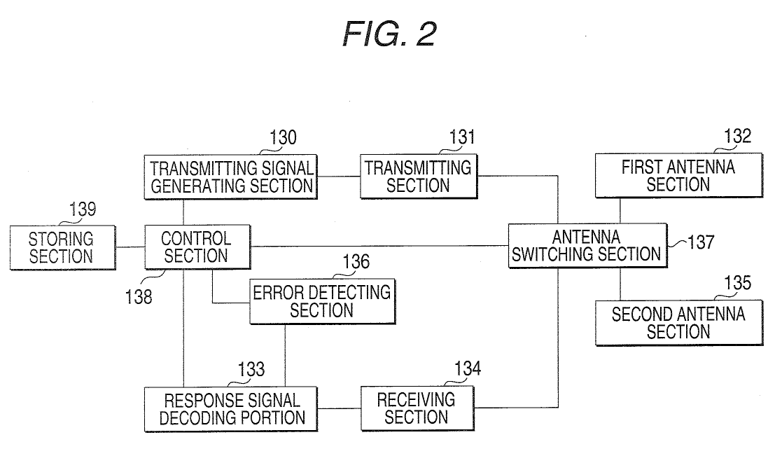

FIG. 2 is a block diagram showing a functional structure according to the first embodiment of the wireless communication apparatus in accordance with the invention. In FIG. 2, a transmitting signal generating section 130 generates a predetermined transmitting signal including a response indicating command for the wireless tag. A transmitting section 131 is connected to the transmitting signal generating section 130, and the transmitting section 131 is connected to a first antenna section 132 through an antenna switching section 137 in order to transmit the transmitting signal generated by the transmitting signal generating section 130. Moreover, a receiving section 134 is connected to a second antenna section 135 through the antenna switching section 137. The receiving section 134 transmits a response signal received by the second antenna section 135 to a response signal decoding section 133, and the response signal decoding section 133 decodes the received signal.

Furthermore, an error detecting section 136 detects any of response signals transmitted from the wireless tag to the response signal decoding section 133 which is an error and transmits a result of the detection to a control section 138. The antenna switching section 137 switches the respective connections of the first antenna section 132 and the second antenna section 135 into the transmitting section 131 or the receiving section 134 in accordance with an instruction given from the control section 138. The control section 138 includes two types of error detecting methods and can select the detecting method through an input section (not shown) in accordance with an instruction given from a user.

Description will be given to a correspondence of the block diagram showing the circuit structure of the wireless communication apparatus according to the embodiment of FIG. 1 and the block diagram showing the function in FIG. 2. The transmitting signal generating section 130 is implemented by the CPU 112. The transmitting section 131 is constituted by the transmitting amplifier 102 and the power amplifier 103. The first antenna section 132 is implemented by the transmitting antenna 100c. The response signal decoding section 133 is implemented by the CPU 112. Moreover, the receiving section 134 is constituted by the distributor 107, the mixers 108a and 108b, the filters 109a and 109b, the receiving amplifiers 110a and 110b, and the AD converter 111. Furthermore, the second antenna section 135 is implemented by the receiving antenna 10I c. The error detecting section 136 is implemented by the CPU 112. The antenna switching section 137 is constituted by the SPDT switches 122c, 123c, 125c and 126c. In addition, the control section 138 is implemented by the CPU 112.

### <Explanation of Antenna Control>

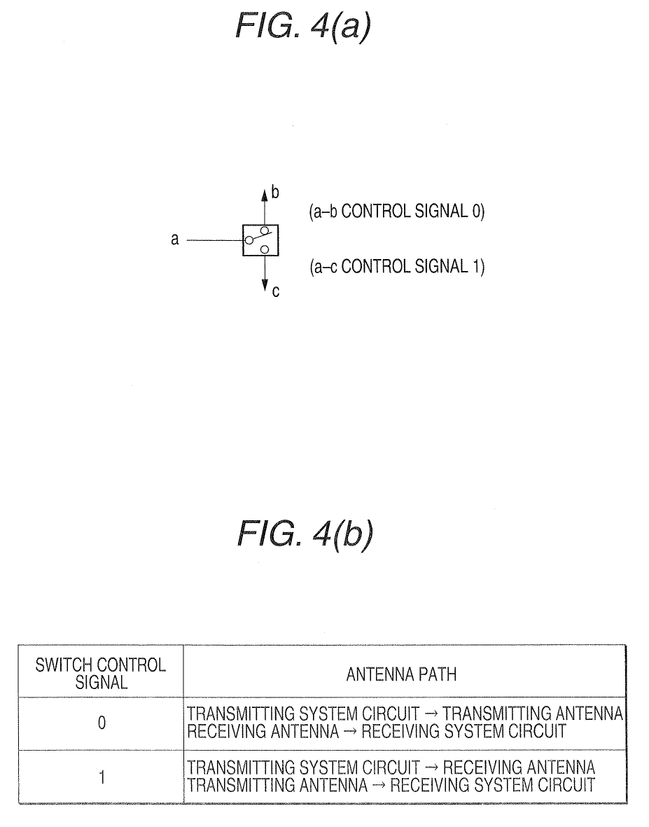

FIG. 4(a) shows an embodiment of a signal path switching control of the SPDT switch for switching the path of the antenna communication shown in FIG. 1. The switch is controlled in such a manner that a path between a and b is effective at a control signal “0” input. Moreover, the switch is controlled in such a manner that a path between a and c is effective at a control signal “1” input. Moreover, FIG. 4(b) shows a control matrix for a relationship between the SPDT switch control signal and the antenna path in FIG. 1. In the first embodiment, an antenna control is carried out through a switch control as shown in FIG. 4(b).

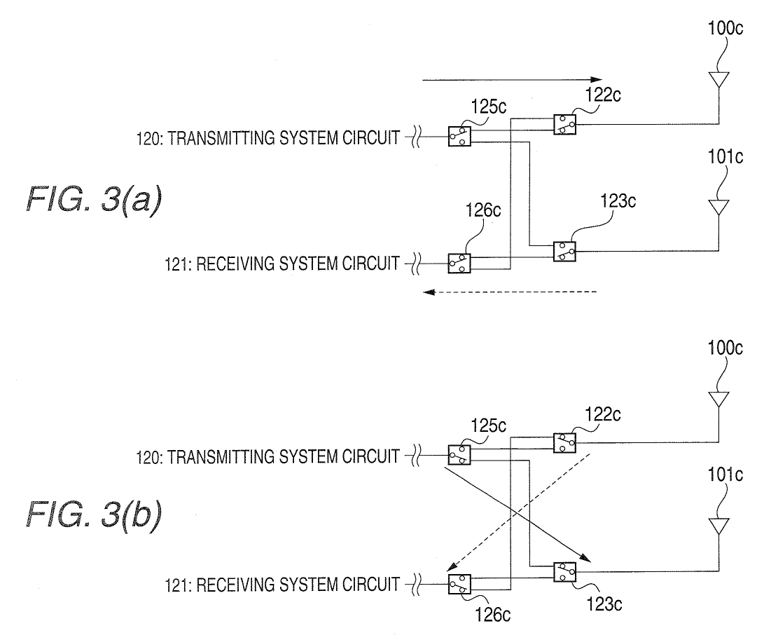

With reference to FIGS. 1 and 3, detailed description will be given to the antenna control according to the first embodiment. The output from the transmitting system circuit 120 is connected to the SPDT switch 122c or the SPDT switch 123c through the SPDT switch 125c.

In the case of FIG. 3(a), the SPDT switch 125c is connected to the SPDT switch 122c, and the output from the transmitting system circuit 120 (see FIG. 1) is sent from the transmitting antenna 100c. At this time, a signal received through the receiving antenna 101c is controlled to be transmitted to the SPDT switch 126c through the SPDT switch 123c, and furthermore, to the receiving system circuit 121. In the system, another communication path can also be controlled.

In the case of FIG. 3(b), moreover, the output from the transmitting system circuit 120 (see FIG. 1) is sent through the receiving antenna 101c because the SPDT switch 125c is connected to the SPDT switch 123c. At this time, the received signal is received at the transmitting antenna 100c and is received by the receiving system circuit 121 via the SPDT switch 126c through the SPDT switch 122c.

In the first embodiment, two switching modes in antenna switching are employed. One of them is a switching mode utilizing a “CRC error detecting method” and the other is a switching mode utilizing a “pilot tone error detecting method”. The two detection switching modes will be described below in detail. CRC indicates “CYCLICAL REDUNDANCY CHECK”. Moreover, the pilot tone indicates a synchronizing signal in a data communication.

### <Schematic Explanation of CRC Error Detection>

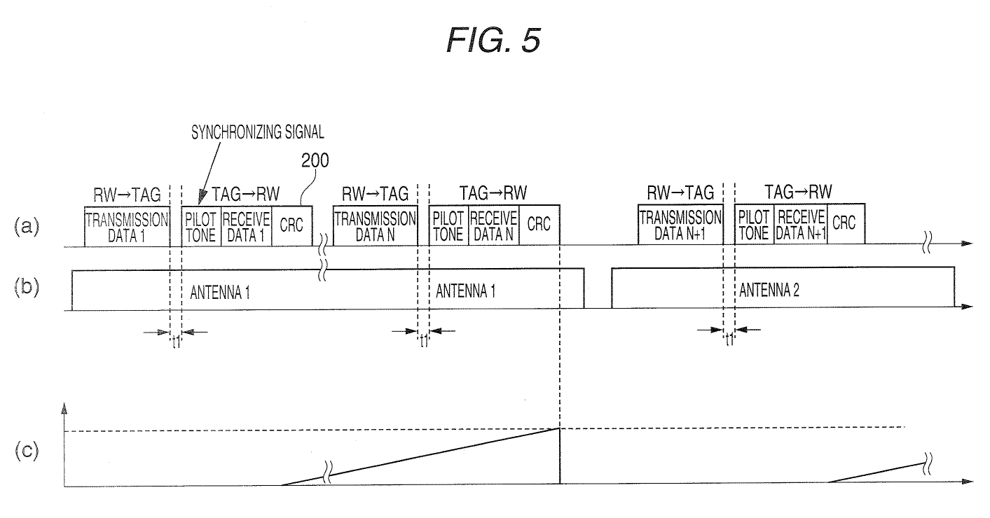

FIG. 5 is an explanatory diagram showing a data flow and an antenna control between the wireless communication apparatus (R/W) and the wireless tag according to the first embodiment of the invention, illustrating an embodiment of the data flow between the wireless communication apparatus (R/W) and the wireless tag and an antenna selection to be carried out through a CRC error detection. In detail, FIG. 5(a) shows the data flow between the wireless communication apparatus and the wireless tag. Moreover, FIG. 5(b) shows an embodiment of a selected antenna in a communication in (a). Only two antennas, that is, the antennas 100c and 101c are used for the antenna. FIG. 5(c) shows an embodiment of a control in which errors included in CRC data between the wireless tag and the wireless communication apparatus are counted and a count value is cleared to “0” when it reaches a set threshold.

First of all, when transmit data are transferred from the wireless communication apparatus to the wireless tag, receive data are received from the wireless tag to the wireless communication apparatus after a certain time (t1). In the communication between the wireless communication apparatus and the wireless tag, the communication of the transmit data and the receive data shown in the drawing is basically repeated. The antenna to be used for the communication is controlled in the repetition. A CRC (an error decision bit) 200 corresponding to the receive data is added to the receive data, and a CRC error (a validity of a relationship between the transmit data and a check code which is added) is decided by the CPU 112. More specifically, the number of the CRC errors is specified at start of the communication with the wireless tag by the CPU 112 and is always counted during the communication. When the number of the CRC errors which is specified is reached, a control is carried out to switch two antennas (the transmission and receipt of the two antennas) to be used for the communication between the wireless communication apparatus and the wireless tag. There is shown an embodiment in which the number of the CRC errors reaches a predetermined number of errors (a set threshold) while the receive data are received at N times. In the receipt of the CRC data in receive data N of FIG. 5(a), the number of the CRC errors reaches a set threshold in FIG. 5(c). The count value is cleared to “0”, and furthermore, the selected antenna is switched from the antenna 100c to the antenna 101c in FIG. 5(b).

Moreover, the number of the CRC errors in the antenna switching is to be set to a more optimum value based on the number of read tags. In the first embodiment, the CRC error is properly controlled by adapting the number of decisions to the number of read tags which are supposed to be present. More specifically, if the number of the read tags is set to be N1, a number e1 of CRC error decisions to be a trigger for carrying out the antenna switching is set to be a value which is proportional to n1. It is assumed that the number of the CRC error decisions to be set is e1>1. In a UHF band reader system, the number of the CRC error decisions is set to be e1=N1/100 to N1. By setting the number e1 of the CRC error decisions to be the equation for the number N1 of the read tags, moreover, it is possible to efficiently read the wireless tag. If e1>n1 is set, there is a possibility a deterioration in a time required for reading the wireless tag might be caused, and furthermore, the antenna switching might not be properly carried out in some cases. e1<n1/100 is not proper because the antenna switching might be frequently carried out. The setting can be carried out by a user through input means (not shown) such as a keyboard.

### <Explanation of Flowchart for Operation Through CRC Error Detection>

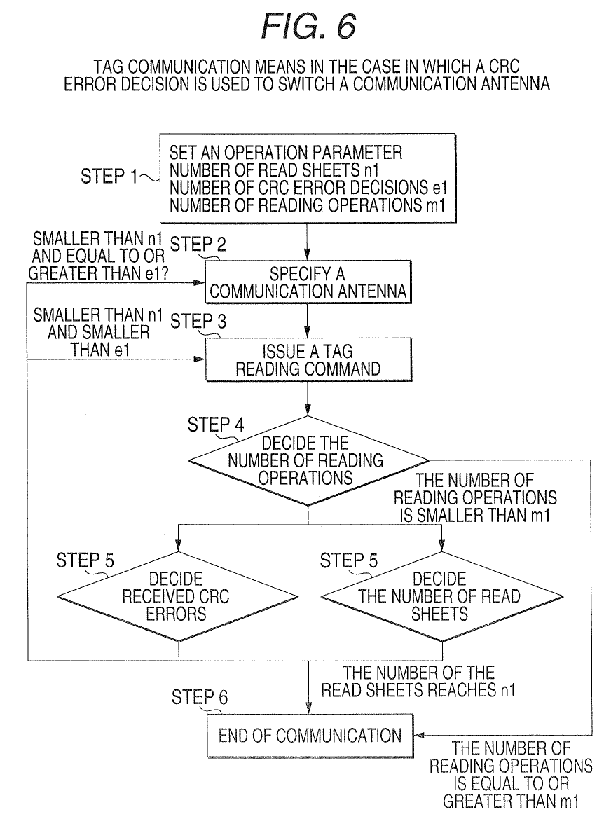

An operation of an antenna switching function in the apparatus according to the first embodiment will be described below with reference to a flowchart. Referring to FIG. 6, description will be given to an antenna switching control procedure through the number of the CRC errors. The user can previously carry out the following setting by input means (not shown) such as a keyboard which is connected to the control section 138.

First of all, the control section sets the number n1 of read sheets in accordance with setting information input by the user (n1 has an equal value to the number of bits which is a random number included in a response signal sent from the tag in some cases) at Step 1. Next, the control section sets the number e1 of CRC error decisions which is proportional to n1, and the number m1 of reading operations in the same manner. Referring to m1, a value which is equal to or greater than the number of read tags is set and m1>n1 is set (in the case of m1<n1, it might be hard to read all of the tags, which is not realistic.).

At Step 2, next, the control section sets a transmitting antenna and a receiving antenna in a read processing. At Step 3, subsequently, the control section executes a read processing and reads the wireless tag. At Step 4, furthermore, the control section decides the number of the reading operations. In addition, when the number of the reading operations reaches m1, the control section ends the communication processing for the reading operation (Step 6). If the number of the reading operations is smaller than m1, the processing proceeds to Step 5.

At the Step 5, next, the control section decides the number of the response CRC errors and the number of the read sheets from the wireless tag. If the number of the CRC errors is equal to or greater than e1 and the number of the read sheets is smaller than n1, moreover, the processing proceeds to the Step 2 in which the communication antenna is switched. If the number of the CRC errors is smaller than e1 and the number of the read sheets is smaller than n1, furthermore, the processing proceeds to the Step 3 in which a tag reading command is issued. If the number of the read sheets reaches nil at the Step 5, moreover, the processing proceeds to the Step 6 in which the communication is ended. There has been described the control for switching the transmitting and receiving antennas based on the CRC error detection.

### <Schematic Explanation of Pilot Tone Error Detection>

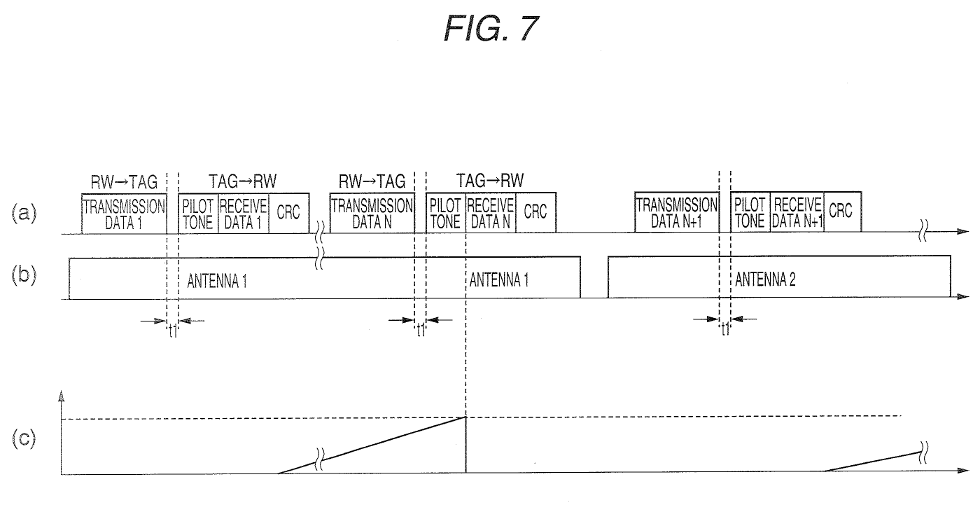

FIG. 7 shows the details of an antenna switching control through a pilot tone error decision. A pilot tone signal implies a synchronizing signal included in communication data transmitted from the wireless tag.

FIG. 7(a) shows a flow of communication data between the wireless tag and the wireless communication apparatus. Moreover, FIG. 7(b) shows an embodiment of an antenna selection in a communication of FIG. 7(a). Only two antennas, that is, the antennas 100c and 101c are used.

FIG. 7(c) shows an embodiment of a control in which errors included in pilot tone data between the wireless tag and the wireless communication apparatus are counted, and a count value is cleared to “0” when a set threshold is reached. In the first embodiment, the number of the pilot tone errors reaches a set error number threshold while receive data are received at N times.

In the receipt of the pilot tone data in the receive data N of FIG. 7(a), the number of the pilot tone errors reaches a set threshold in FIG. 7(c) and a count value is cleared to “0”, and furthermore, the selected antenna is switched from the antenna 100c to the antenna 101c in FIG. 7(b). In addition, the number of the pilot tone errors in the antenna switching is to be set to a more optimum value based on the number of wireless tags which are read. In the first embodiment, the pilot tone error is properly controlled by adapting the number of decisions to the number of read wireless tags which are supposed to be present. More specifically, if the number of the read tags is set to be N1, a number p1 of pilot tone error decisions to be a trigger for carrying out the antenna switching is set to be a value which is proportional to N1. It is assumed that the number of the pilot tone error decisions to be set is p1>1. In a UHF band reader system, p1=N1/100 to N1 is set. By setting the number p1 of the pilot tone error decisions to be the equation for the number N1 of the read tags, it is possible to efficiently read the tag. If p1>N1 is set, moreover, there is a possibility that a deterioration in a time required for reading the tag might be caused, and furthermore, the antenna switching might not be properly carried out in some cases. p1<N1/100 is not proper because the antenna switching might be frequently carried out.

The pilot tone error includes the case in which it is detected that a pilot tone contained in a response data head sent from the tag is different from an original signal and the case in which a level of data to be received is lower than a threshold.

### <Explanation of Flowchart for Operation Through Pilot Tone Error Detection>

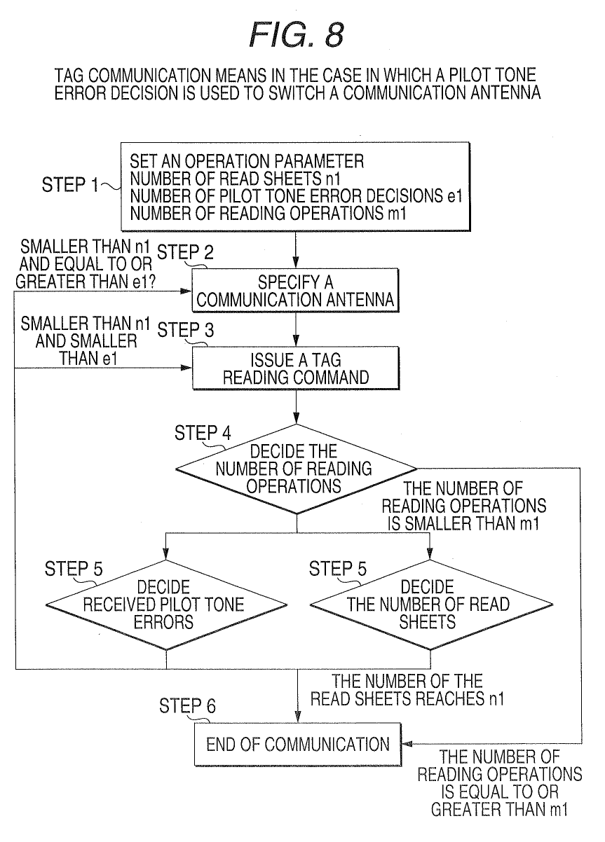

An operation of the function of the apparatus according to the first embodiment will be described below with reference to a flowchart of FIG. 8. The function indicates antenna switching to be carried out by the detection of a pilot tone error included in data received from the tag.

First of all, the control section sets the number n1 of read sheets in accordance with setting information which is input (n1 has an equal value to the number of bits which is a random number included in a response signal sent from the tag in some cases) at Step 1. Next, the control section sets the number p1 of pilot tone error decisions which is proportional to n1, and the number m1 of reading operations in the same manner. The pilot tone error is detected as an error when responses given from a plurality of tags meet each other so that the pilot tone is broken and cannot be detected (moreover, the pilot tone is broken by the influence of a noise in an environment so that the error is detected). Referring to m1, a value which is equal to or greater than the number of read tags is set and m1>n1 is set (in the case of m1<n1, it might be hard to read all of the tags, which is not realistic.).

At Step 2, next, the control section sets a transmitting antenna and a receiving antenna which serve to carry out a reading operation in the same manner. At Step 3, subsequently, the control section executes a read processing and reads the tag. At Step 4, furthermore, the control section decides the number of the reading operations. When the number of the reading operations reaches m1, the control section ends the communication processing (Step 6). If the number of the reading operations is smaller than m1, the processing proceeds to Step 5.

At the Step 5, next, the control section compares the number of response pilot tone errors sent from the tag with the number of the read sheets and decides them. If the number of the pilot tone errors is equal to or greater than e1 and the number of the read sheets is smaller than n1, the control section switches the communication antenna and the processing proceeds to the Step 2. If the number of the pilot tone errors is smaller than e1 and the number of the read sheets is smaller than nil, the control section gives an instruction for issuing a tag reading command to the transmitting signal generating section 130 and the processing proceeds to the Step 3. If the number m1 of the read sheets is set to be a great value, the same control as the decision of only the number of the pilot tone errors is carried out. If the number of the read sheets reaches n1 at the Step 5, moreover, the processing proceeds to Step 6 and the communication is ended.

There has been described the control for switching the antenna based on the pilot tone error.

### Second Embodiment

A second embodiment according to the invention will be described below with reference to the drawings. A structural difference from the first embodiment according to the invention is the antenna switching section 2 and a plurality of transmitting and receiving antennas in FIG. 1 and detailed description thereof will be given.

### <Explanation of Structure of Antennas>

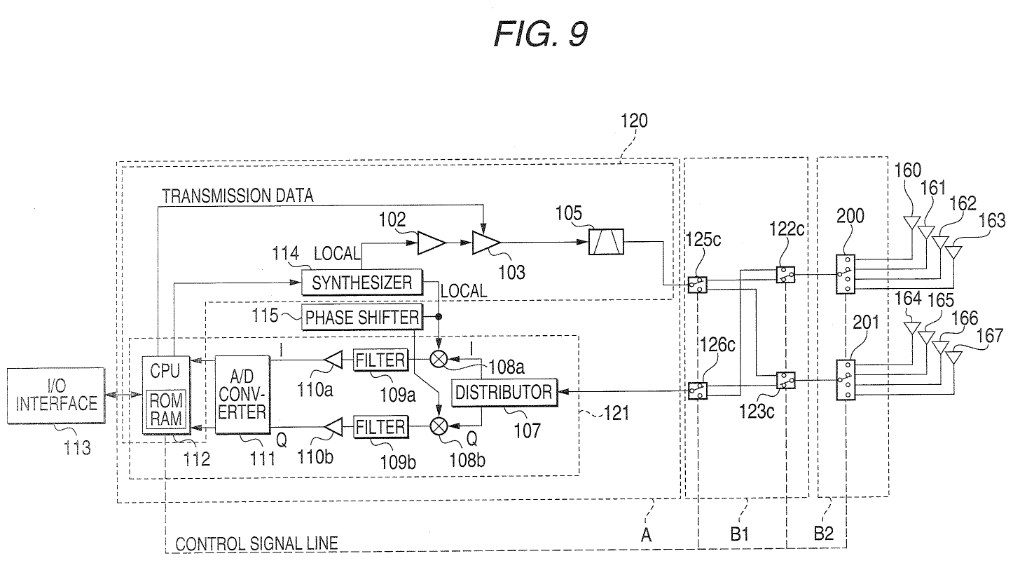

FIG. 9 is a block diagram showing an embodiment of a diversity structure in which a switch change-over section B2 (hereinafter referred to as a “branch switch section”) for a plurality of branch antennas is connected to an SPDT switch 122c and an SPDT switch 123c in FIG. 1.

In the embodiment, branch switch sections 200 and 201 having a plurality of antennas are changed over by using an SP4T (Single Pole Fourth Throw) switch so that four antennas for transmission and receipt can be switched. Moreover, the antennas have directivities of transmission and receipt of a radio wave which are different from each other.

A structure of a wireless communication apparatus according to the second embodiment and a method of controlling the same will be described below in more detail. Also in the embodiment, a CRC error detection and a pilot tone error detection are utilized for switching the antennas in the same manner as in the first embodiment.

An output from a transmitting system circuit 120 is first transmitted to an SPDT switch 125c. In the SPDT switch 125c, a 1-bit control signal is transmitted to the SP4T switch 200 on a transmitting antenna side via an SPDT switch 122c and the SP4T switch 201 on a receiving antenna side via an SPDT switch 123c, respectively.

In the case in which the control signal is transmitted to the SP4T switch 200 on the transmitting antenna side, the output of the transmitting system circuit 120 is sent from one of transmitting antennas 160 to 163. In the case in which the control signal is transmitted to the SP4T switch 201 on the receiving side, moreover, the output of the transmitting system circuit 120 is sent from one of receiving antennas 164 to 167.

More specifically, a transmitting signal is selected to be transmitted through the transmitting antenna or the receiving antenna by means of the SPDT switches 125c, 122c and 123c. Accordingly, in the case in which the output of the transmitting system circuit 120 is sent from the transmitting antennas 160 to 163, for embodiment, it is output through one of four antennas, that is, the receiving antennas 164 to 167. The selection of the antenna at that time is carried out based on a result of the detection of the received CRC error in the apparatus body.

CRC indicates “CYCLICAL REDUNDANCY CHECK”. The CRC data imply a redundancy code for an error decision which is added to the response data transferred from the tag and are used for decoding the redundancy code and deciding whether the normal received data are responded or not. In the embodiment, moreover, the antenna is selected based on the result of the detection of the pilot tone error.

The pilot tone indicates a code for a signal synchronization which is included in a head of the response data transferred from the tag. Based on the code, a response signal sent from the tag is decided and synchronized in the apparatus body. Moreover, the code for the synchronization is varied depending on a type of the tag. Therefore, it is also possible to synchronize and receive various types of tags.

In the embodiment, the decision is carried out through the CRC error or the pilot tone error to switch the antenna. However, a deciding procedure for selecting the antenna is the same as that in the first embodiment.

Also in the receiving system, similarly, a received signal sent from one of the receiving antennas 164 to 167 passes through the SP4T switch 201 and is then input to the receiving system circuit 121 via the SPDT switch 126c through the SPDT switch 123c or a received signal sent from one of the transmitting antennas 160 to 163 passes through the SP4T switch 200 and is then input to a receiving system circuit 121 via the SPDT switch 122c through the SPDT switch 126c (selectable). For embodiment, in the case in which the input of the receiving system circuit 121 is received by the transmitting antennas 160 to 163, it is received by one of the four receiving antennas 164 to 167. The selection of the antenna at that time is decided through the receiving CRC error or the pilot tone error in the apparatus body and the antenna is switched.

As described above, in the embodiment, the decision is carried out based on the CRC error or the pilot tone error and the antenna is switched. However, the deciding procedure for selecting the antenna is the same as that in the first embodiment.

In the method described above, a control for switching the transmitting and receiving antennas can be carried out in a transmission and a receipt. Moreover, a control for switching four branch antennas is carried out by the SP4T switches 200 and 201.

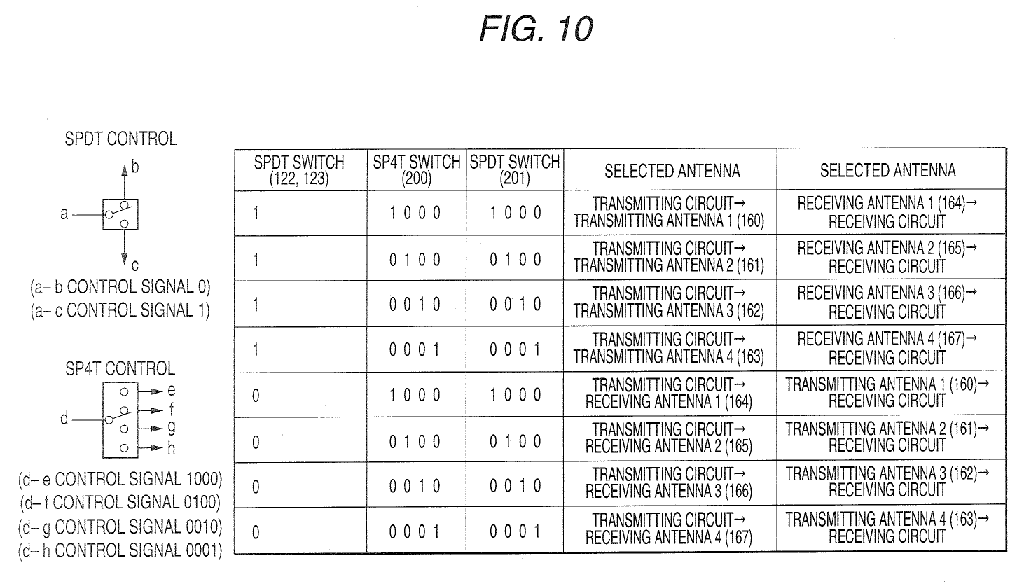

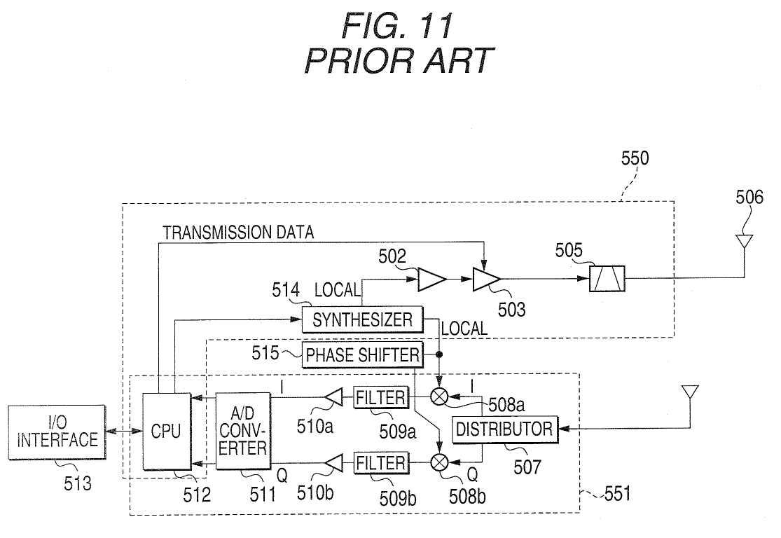

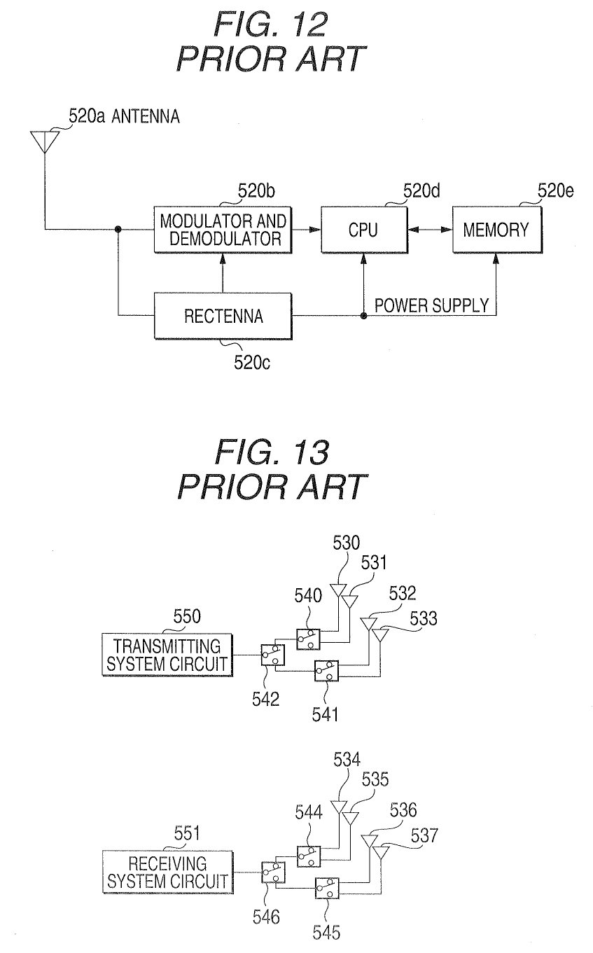

A specific antenna control according to the embodiment is carried out in accordance with a matrix shown in FIG. 10. As shown in FIG. 10, in the case in which the antenna 160 is selected as the transmitting antenna, the antenna 164 is selected as the receiving antenna. In the case in which the antenna 161 is selected as the transmitting antenna, moreover, the antenna 165 is selected as the receiving antenna. More specifically, in the embodiment, one of the antennas for a transmission and one of the antennas for a receipt make a pair, and transmitting and receiving functions are switched in accordance with the result of the detection of the received CRC error or pilot tone error.

There has been described the embodiment of the control for two SPDT switches and two SP4T switches. By constituting the SP4T switches 200 and 201 to be SP5T and SP6T, however, it is possible to increase the number of the branches of the transmitting and receiving antennas to be five or six. With the structure, moreover, it is possible to carry out a phase control for a signal by providing a phase shifter in the middle of a path. In addition, it is also possible to carry out an antenna control for a plurality of branches in a combination of SPDT switches in place of the SP4T switches 200 and 201. With the structures of the SP4T switch and the SPDT switch described above, moreover, it is also possible to use MMIC dedicated to a switch. By employing a switch structure in which an ON/OFF control is carried out through a bias of a PIN diode, it is possible to implement the switch with an inexpensive structure.

Referring to the control section, in the same manner as in the first embodiment, the error detection of the error detecting section has a mode for detecting an error related to the CRC in the response signal which is received and a mode for detecting an error related to the pilot tone in the response signal which is received, and a user can switch both of the modes by input means which is not shown.

### Third Embodiment

In a third embodiment, a structure of an apparatus is the same as that in the second embodiment and an antenna switching control to be carried out by the switch group is different from that in the second embodiment. More specifically, a CPU (a control section and an error detecting section) carries out the CRC error detection or the pilot tone error detection. In the case in which an antenna is switched by the detection of the error, only branch switch sections 200 and 201 are operated.

For embodiment, in the case in which an antenna 160 is selected as a transmitting antenna and an antenna 164 is selected as a receiving antenna, a change is carried out to select an antenna 163 as the transmitting antenna or to select an antenna 167 as the receiving antenna based on a result of the detection of the received CRC error or the pilot tone error.

In other words, in the embodiment, two modes, that is, modes A and B are provided. In the mode A, by the detection, the control section first carries out switching into the most distant antenna from one of the antennas 160 to 163 which is being coupled to the branch switch section 200 or switching from a current one of the antennas 164 to 167 to be coupled to the branch switch section 201 to the most distant antenna. In the mode B, by the detection, the control section carries out switching into a different one of the antennas 160 to 163 to be coupled to the branch switch section 200 from the antenna which is being coupled.

It is possible to freely set an order for switching a current one of the antennas 164 to 167 to be coupled to the branch switch section 201. A user carries out the mode switching by utilizing input means (not shown) such as a keyboard.

Referring to the control section, in the same manner as in the first embodiment, the error detection of the error detecting section has a mode for detecting an error related to the CRC in the response signal which is received and a mode for detecting an error related to the pilot tone in the response signal which is received, and both of the modes are switched.

As described above, in the embodiment, it is possible to control a signal path in accordance with a switch matrix. In the embodiment, with the structure, it is possible to obtain a high diversity effect with a very simple structure by switching a first antenna section from a transmitting side into a receiving side and a second antenna section into the receiving side based on the result of the detection obtained by the error detecting section.

Many modifications and variations of the present invention are possible in the light of the above techniques. It is therefore to be understood that within the scope of the invention the invention may be practiced otherwise than as specifically described.

This application is based upon and claims the benefit of priority of Japanese Patent Application No. 2006-163 filed on Jun. 13, 2006, the contents of which are incorporated herein by reference in its entirety.

What is claimed is:

1. A wireless communication apparatus comprising:
a first antenna section;
a second antenna section;
a transmitting signal generating section configured to generate a predetermined transmitting signal for a wireless tag;
a transmitting section configured to transmit the transmitting signal generated by the transmitting signal generating section from the first antenna section;
a receiving section configured to receive a response signal from the wireless tag through the second antenna section;
an error detecting section configured to detect a predetermined error in the response signal sent from the wireless tag and received by the antenna section; and
an antenna switching section configured to carry out switching for receiving the response signal sent from the tag through the first antenna section and transmitting the predetermined transmitting signal through the second antenna section based on a result of the detection obtained by the error detecting section.

2. The wireless communication apparatus according to claim 1, wherein the predetermined error is a CRC (Cyclical Redundancy Check) error of a predetermined times within a predetermined time period in the response signal.

3. The wireless communication apparatus according to claim 1, wherein the predetermined error is a pilot tone error of a predetermined times within a predetermined time period in the response signal.

4. The wireless communication apparatus according to claim 1, wherein the error detection of the error detecting section has a mode for detecting an error related to CRC in the response signal which is received and a mode for detecting an error related to a pilot tone in the response signal which is received, and a control section for switching both of the modes is provided.

5. The wire communication apparatus according to claim 4, wherein the apparatus further comprises a controller configured to change from the first detection mode to the second detection mode.

6. A wireless communication apparatus comprising:
a first antenna section;
a second antenna section;
a transmitting signal generating section configured to generate a predetermined transmitting signal for a wireless tag;
a transmitting section configured to transmit the transmitting signal generated by the transmitting signal generating section from the first antenna section;
a receiving section configured to receive a response signal from the wireless tag through the second antenna section;
an error detecting section configured to detect a predetermined error in the response signal sent from the wireless tag and received by the antenna section;
each of the first antenna section and the second antenna section having a plurality of antennas, and
a switching section configured to change an antenna for outputting the transmitting signal generated by the signal generating section from one of the antennas in the first antenna section to one of the antennas in the second antenna section or to change an antenna for transmitting the received signal to the receiving section from one of the antennas in the second antenna section to one of the antennas in the first antenna section.

7. The wireless communication apparatus according to claim 6, wherein, when the predetermined communication error is detected by the detector, the switching section couples the transmitting section with one of the plurality of the antennas included in the second antenna section and couples the receiving section with one of the plurality of the antenna included in the first antenna section.

8. The wireless communication apparatus according to claim 7, wherein the predetermined detection error is a CRC error of a predetermined times within a predetermined time period in the response signal.

9. The wireless communication apparatus according to claim 7, wherein the predetermined detection error is a pilot tone error of a predetermined times within a predetermined time period in the response signal.

10. A method for controlling a wireless communication apparatus, the wireless communication apparatus communicating with an IC tag, the wireless communication apparatus having a first antenna section and a second antenna section, the wireless communication apparatus having a transmitting section that transmits predetermined data to the tag through the first antenna section, the wireless communication apparatus having a receiving section that receives response data from the tag through the second antenna section, the method comprising the steps:
detecting a predetermined communication error, based on the response data received from the second antenna section; and
coupling the first antenna section with the receiving section and coupling the second antenna section with the transmitting section when a communication error is detected so that the transmitting section transmits the predetermined data to the tag through the second antenna section, and the receiving section receives the response data from the tag through the first antenna section.

11. The method for controlling a wireless communication apparatus according to claim 10, wherein the detector detects the predetermined communication error, by detecting a CRC (Cyclical Redundancy Check) error predetermined times within a predetermined time period.

12. The method for controlling a wireless communication apparatus according to claim 10, wherein the detector detects the predetermined communication error, by detecting a pilot tone error predetermined times within a predetermined time period.
